(19) United States
(12) Patent Application Publication
(10) Pub. No.: US 2005/0190649 A1
(43) Pub. Date: Sep. 1, 2005

(54) Method for monitoring seismic events

(75) Inventors: Leo Eisner, Cambridge (GB); Paolo Primiero, Trieste (IT)

Correspondence Address: SCHLUMBERGER-DOLL RESEARCH, 36 OLD QUARRY ROAD, RIDGEFIELD, CT, 06877-4108, US

(73) Assignees: WesternGeco L.L.C., Houston, TX (US); a Delaware Limited Liability coompany

(21) Appl. No.: 11/019,401

(22) Filed: Dec. 22, 2004

(30) Foreign Application Priority Data
Dec. 29, 2003 (GB) 0330097.7

(51) Int. Cl. G01V 1/28

(52) U.S. Cl. 367/38

(57) ABSTRACT

A microseismic method of monitoring fracturing operation or other passive seismic events in hydrocarbon wells is described using the steps of obtaining multi-component signal recordings from locations in the vicinity of a facture; and performing a waveform inversion to determine parameters representing a source characteristics of the event.

This invention relates to methods for acquiring seismic data passively monitoring seismic events such as acoustic signals generated through producing a hydrocarbon reservoir or using hydraulic stimulation such as fracturing rock layers to improve hydrocarbon production of a well or reservoir. More specifically it relates to such methods using seismic methods to determine the source characteristics and location of such events.

### BACKGROUND OF THE INVENTION

Seismic monitoring is known as a method with an observation horizon that penetrates far deeper into a hydrocarbon reservoir than any other method employed in the oilfield industry. It has been proposed to exploit the reach of seismic methods for the purpose of reservoir monitoring.

In conventional seismic monitoring a seismic source, such as airguns, vibrators or explosives are activated and generate sufficient acoustic energy to penetrate the earth. Reflected or refracted parts of this energy are then recorded by seismic receivers such as hydrophones and geophones.

The passive seismic monitoring there is no actively controlled and triggered source. The seismic energy is generated through so-called microseismic events caused by subterranean shifts and changes that at least partially give rise to acoustic waves which in turn can be recorded using the known receivers.

Apart from the problem of detecting the often faint microseimic events, their interpretation is difficult as neither the source location nor the source signature or characteristics are known a priori. However knowledge of these parameters are essentially to deduce further reservoir parameters which would allow for improved reservoir control.

A specific field with the area of passive seismic monitoring is the monitoring of hydraulic fracturing. To improve production or where reservoirs are used for storage purposes workers in the oil and gas industry perform a procedure known as hydraulic fracturing. For example, in formations where oil or gas cannot be easily or economically extracted from the earth, a hydraulic fracturing operation is commonly performed. Such a hydraulic fracturing operation includes pumping in large amounts of fluid to induce cracks in the earth, thereby creating pathways via which the oil and gas may flow. After a crack is generated, sand or some other material is commonly added to the crack, so that when the earth closes back up after the pressure is released, the sand helps to keep the earth parted. The sand then provides a conductive pathway for the oil and gas to flow from the newly formed fracture

However, the hydraulic fracturing process does not always work very well. The reasons for this are relatively unknown. In addition, the hydraulic fractures cannot be readily observed, since they are typically thousands of feet below the surface of the earth. Therefore, members of the oil and gas industry have sought diagnostic methods to tell where the fractures are, how big the fractures are, how far they go and how high they grow. Thus, a diagnostic apparatus and method for measuring the hydraulic fracture and the rock deformation around the fracture are needed.

In previous attempts to solve this problem, certain methods have been developed for mapping fractures. For example, one of these methods involves seismic sensing. In such a seismic sensing operation, micro-earthquakes generated by the fracturing are analyzed by seismic meters, for example, accelerometers.

A recent study on the use of microseismic imaging for fracture stimulation was published by J. T. Rutledge and W. S. Phillips. In an typical operational setting as described in greater detail in FIG. 1 below, three-component geophones were used to monitor a well during fracturing. The recordings of the geophones are then converted into arrival times and source location using an iterative, least square method.

The present invention seeks to improve the amount of information gained from microseismic imaging of a reservoir in particular of fracturing operations.

### SUMMARY OF THE INVENTION

The invention describes a method of processing passive seismic events including microseismic events or fracturing to determine the source characteristics, origin time or location of the origin of these events by means of waveform inversion. In contrast to known methods the method of the present invention can be applied to the waveform as recorded and does, for example not require detection of specific seismic phases (such as P or S waves) or other parameters derived from data (e.g. polarization angles). The full waveform are data recorded using three components geophones.

Preferably the obtained signals are low-pass or band filtered to a frequency range of 100 Hz or lower, or more preferably to 50 Hz an lower.

The algorithm is suitable for inversion in an arbitrary heterogeneous medium and takes advantage of a good velocity and density model, if it is available. An alternative version of the inversion algorithm (with location or origin time of the seismic source determined independently) can be used to invert for the characteristics or mechanism of the source only. A preferred example of an important source characteristic is its moment tensor.

The algorithm preferably uses reciprocity of the source and receivers by evaluating Green's functions in an arbitrary heterogeneous medium from the receiver locations. These Green's functions are then inverted to evaluate synthetic seismograms due to an arbitrary source mechanism from source locations.

Using preferably search algorithms known per se such as a grid search over all possible source locations and origin times, the full waveform synthetic seismograms are fitted to the data by the least-square method. The initial estimate of the origin time is set through cross-correlation of data and synthetics due to an arbitrary source mechanism.

The inverted origin time is determined by a grid search around this initial estimate. The algorithm is robust to white noise added to the synthetic seismograms and is robust and particularly suitable for low frequency data in the frequency band from 0 Hz to 100 Hz, more preferably 0 Hz to 50 Hz.

These and further aspects of the invention are described in detail in the following examples and accompanying drawings.

### BRIEF DESCRIPTION OF THE DRAWINGS

The invention will now be described, by way of example only, with reference to the accompanying drawings, of which:

FIG. 1 shows a schematic illustration of a fracturing operation;

FIG. 2 is a flowchart of steps performed in an example of the present invention; and

FIG. 3 is a comparison of synthetic data with data derived using an example of the present invention.

### DETAILED DESCRIPTION

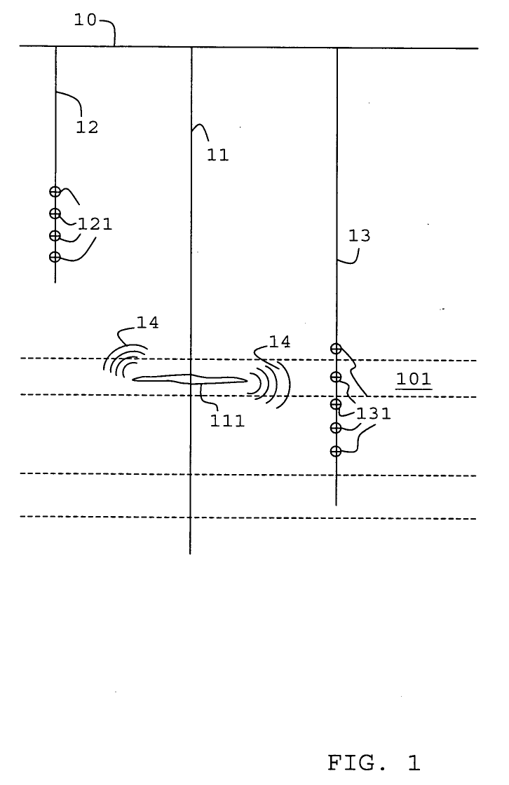

A typical operational setting for monitoring hydraulic fracturing is illustrated in FIG. 1 with a treatment well 11 and geophone arrays 121, 131 located in neighboring wells or holes 12, 13. During the fracturing operation a fluid is pumped from the surface 10 into the well 11 causing the surrounding formation in a hydrocarbon bearing layer 101 to fracture. Acoustic waves 14 generated by the fracture 111 propagate through the earth and are recorded by the three-components geophones of the two arrays 121, 131.

For the present invention it is assumed that three components of the time history of particle velocity (or particle displacement) at several (N_r) downhole receivers were recorded during an acoustic emission. Furthermore, it is assumed the existence of an velocity model (of arbitrary complexity) of the volume of earth through which the seismic waves travels. The quality of the velocity model can be characterized by the length of time interval T_i (i=1 . . . N_r) for which one is confident a synthetic seismograms can fit the data. These time intervals preferably include at least the S-wave arrival at all of the receivers. The use the particle displacement is preferred as it stabilizes the inversion as the particle velocity is more oscillatory than particle displacement.

To find the relevant source parameters such as location vector x_s, origin time t_{—}0 and moment tensor M, the misfit between a synthetic seismograms and data is minimized. In this inversion the misfit is defined by equation [1]:

$$Δ = {\sum }_{i = 0}^{{N}_{T}} {\sum }_{j = 0}^{3} {\int }_{0}^{{T}_{i}} {( {d}_{j} ( {x}_{r}^{i} , t - {t}_{0} ) - {U}_{j} ( {x}_{s} , {x}_{r}^{i} , t , M ) )}^{2} ⅆ t \qquad [ 1 ]$$

where d_j denotes a component of the particle velocity recorded at the i-th receiver and U_j is the j-th component of the synthetic seismogram at the i-th receiver due to a source located at x_s characterized by a moment tensor M. To facilitate the description characters following a underscore appear as subscript in the equations.

The source parameters that minimize equation [1] comprise the inverted solution. The j-th component of a synthetic seismogram at i-th receiver xⁱ_r due to sources at locations x_s can be evaluated from the well known relation

$${U}_{j} ( {x}_{s} , {x}_{r}^{i} , t , M ) = {\sum }_{{x}_{s}} {G}_{kj , m} ( {x}_{s} , {x}_{r}^{i} , t ) * {M}_{k m} ( {x}_{s} , t ) . \qquad [ 2 ]$$

Here “*” is a convolution in time, G_kj,m is the derivative of the Green's function along m-th coordinate axis and M_jk is a moment tensor of a point source located at x_s.

The least-square minimum of the misfit given by equation [1] is in general non-unique. To alleviate this problem, it is preferred to make two assumptions: Firstly, approximating the source as a single point source x_s so that the sum over x_s in equation [2] disappears. Secondly, the source-time function can be approximated as a delta source-time function so that the convolution in the equation [2] is replaced by a multiplication. Using these approximations the equation [2] reduces to

$$\begin{matrix}{U}_{j} ( {x}_{s} , {x}_{r}^{i} , t , M ) = {G}_{ij , k} ( {x}_{s} , {x}_{r}^{i} , t ) \cdot {M}_{jk} ( {x}_{s} ) \\ = {G}_{1 j , 1} ( {x}_{s} , {x}_{r}^{i} , t ) \cdot {M}_{11} ( {x}_{s} ) + \\ {G}_{2 j , 2} ( {x}_{s} , {x}_{r}^{i} , t ) \cdot {M}_{22} ( {x}_{s} ) + \\ {G}_{3 j , 3} ( {x}_{s} , {x}_{r}^{i} , t ) \cdot {M}_{33} ( {x}_{s} ) + \\ ( {G}_{2 j , 1} ( {x}_{s} , {x}_{r}^{i} , t ) + {G}_{1 j , 2} ( {x}_{s} , {x}_{r}^{i} , t ) ) \cdot {M}_{21} ( {x}_{s} ) + \\ ( {G}_{3 j , 1} ( {x}_{s} , {x}_{r}^{i} , t ) + {G}_{3 j , 1} ( {x}_{s} , {x}_{r}^{i} , t ) ) \cdot {M}_{31} ( {x}_{s} ) + \\ ( {G}_{3 j , 2} ( {x}_{s} , {x}_{r}^{i} , t ) + {G}_{3 j , 2} ( {x}_{s} , {x}_{r}^{i} , t ) ) \cdot {M}_{32} ( {x}_{s} ) .\end{matrix} \qquad [ 3 ]$$

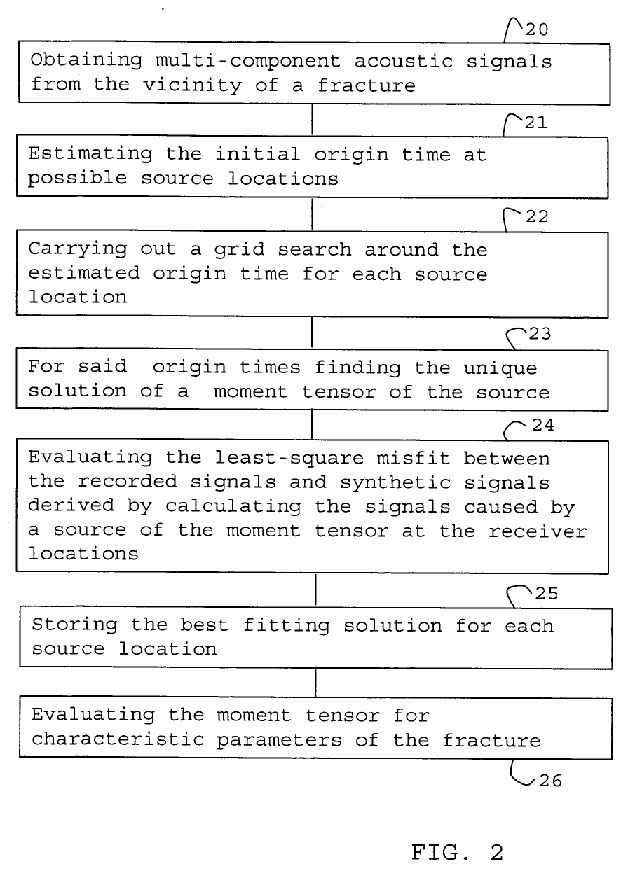

It is known that equation [3] has a unique solution for M with a fixed origin time t_{—}0, point-source location x_s and inversion model. Therefore, the trade-off among the source parameters can be minimized by a grid search over source locations and origin times for the best fitting moment tensors. The grid search for all possible origin times is numerically expensive and is therefore accelerated by estimating the origin time from cross-correlation of the synthetics and data and then using the grid-searching around this initial guess. The method used includes the following steps as illustrated in FIG. 2:
Following a recording of acoustic data from a fracture (Step 20);
estimate the initial origin time t 0(x_s) at every possible source location x_s (Step 21);
carry out a grid search around the estimated origin time for each source location (Step 22). For each origin time find the unique solution M(x_s,t_{—}0(x_s)) (least-square minimum) (Step 23) and evaluate the least-square misfit between the data and the synthetics (Step 24); and
store the best fitting solution for each source location (Step 25).

The moment tensor of fracture together with the origin time and location can then be further evaluated (Step 26) as described below to find characteristics of the fracture.

The initial estimate of the origin time is evaluated by cross-correlation of the data and synthetic seismograms for an chosen source mechanism, e.g. vertical strike-slip. The cross-correlation is evaluated over the time interval $(0, T_j) for each receiver j. The absolute values of the corresponding components for each receiver are cross-correlated and the time shifts of the maximum cross-correlation for each component are calculated. Using the absolute values of the seismograms for the cross-correlation reduces the dependency on the unknown source mechanism. The time shifts of each component and the known origin times of synthetic seismograms enables an estimation of the absolute origin time t^{o}_ij for each component i and receiver j. The estimates are weighted by the maximum amplitude of the recorded seismograms to reduce poor estimates resulting from cross-correlating traces dominated by noise. It is worth noting that using the maximum amplitude as a weight in averaging the origin time assumes that the signal-to-noise ratio is proportional to the maximum amplitude of the recorded seismograms. The final estimate of the origin time is therefore an arithmetic weighted-average with weights of maximum amplitudes A_ij of i-th component at j-th receiver:

$${t}_{0} ( {x}_{s} ) = \frac{{\sum }_{j = 0}^{{N}_{T}} {\sum }_{i = 0}^{3} {t}_{ij}^{o} {A}_{ij}}{{\sum }_{j = 0}^{{N}_{T}} {\sum }_{i = 0}^{3} {A}_{ij}} . \qquad [ 4 ]$$

This cross-correlation can be further improved at the expense of a more time intensive calculation by using the signal envelopes instead of the amplitudes.

The true origin time is then found by grid-search around the initial estimate of the origin time within the dominant [shortest] period in the signal. The limiting of the grid search to the dominant period of the signal requires the initial estimate of the origin time [4] to be within the dominant period. This is typically the case for the S-wave arrival. The grid search around the initial estimate of the origin time [4] eliminates the problems with the cycle-skipping as the cross-correlation function tends to peak every ½-period of the dominant period (usually the minimum period present in the data).

The length of the time step in the grid search is set to obtain the required accuracy of the misfit [1]. Assuming that the synthetic seismograms match the data (i.e. using the true moment mechanism and evaluating the synthetic seismograms in the true model from the true source location), normalized misfit of a harmonic signal with period T, due to a time shift of αT in the origin time, can be evaluated as

$$E = \frac{{\int }_{0}^{T} {[ sin ( ω t ) - sin ( ω ( t + α T ) ) ]}^{2} ⅆ t}{2 {\int }_{0}^{T} {[ sin ( ω t ) ]}^{2} ⅆ t} = 1 - cos ( 2 πα ) . \qquad [ 5 ]$$

The definition of error in equation [5] has a maximum of 2 for ½ period shift and even a small time shift causes a large error for a misfit defined analogously to equation [1]. The length of time step for the grid search can be set to 2αT for which the maximum error of evaluation of misfit reaches a certain limit. For example, a shift of 0.05 T$ (α=0.05) may cause relative error E=0.05. Thus, a search for origin time with a grid step of 0.1T (T is the dominant period in my seismograms) should not cause an error of evaluation in the misfit function larger than 0.05.

The last part of the method is to identify a unique solution M(x_s, t_{—}0(x_s)) for each origin time and source location. It is known that the moment tensor with the least-square minimum fit of the equation [1] is:
\overline{M}ᵢ(xₛ)=(A⁻¹)ᵢⱼ(xₛ)Dⱼ(xₛ). [6]

Here M_I(bar) is the i-th component of six elements vector: M_I(bar)=M_{—}11, M_{—}2(bar)=M_{—}12=M_{—}21, M_{—}3(bar)=M_{—}22, M_{—}4(bar)=M_{—}13=M_{—}31, M_{—}5(bar)=M_{—}3=M_{—}32, M_{—}6(bar)=M_{—}33, and D has six independent elements

$${D}_{k} ( {x}_{s} ) = {\sum }_{i = 0}^{{N}_{T}} {\sum }_{j = 0}^{3} {\int }_{0}^{{T}_{i}} {g}_{jk} ( {x}_{s} , {x}_{r}^{i} , t - {t}_{0} ) {d}_{j} ( {x}_{r}^{i} , t ) ⅆ t . \qquad [ 7 ]$$

Here k=0 . . . 5 and g_jk is defined by the following notation:
gⱼ₁(xₛ,xᵣ,t)=G_{1j,1}(xₛ,xᵣ,t)
gⱼ₂(xₛ,xᵣ,t)=G_{2j,1}(xₛ,xᵣ,t)+G_{1j,2}(xₛ,xᵣ,t)
gⱼ₃(xₛ,xᵣ,t)=G_{2j,2}(xₛ,xᵣ,t)
gⱼ₄(xₛ,xᵣ,t)=G_{3j,1}(xₛ,xᵣ,t)+G_{1j,3}(xₛ,xᵣ,t)
gⱼ₅(xₛ,xᵣ,t)=G_{3j,2}(xₛ,xᵣ,t)+G_{2j,3}(xₛ,xᵣ,t)
gⱼ₆(xₛ,xᵣ,t)=G_{3j,3}(xₛ,xᵣ,t). [8]

Finally, A is a 6×6 matrix with elements:

$${A}_{kl} ( {x}_{s} ) = {\sum }_{i = 0}^{{N}_{T}} {\sum }_{j = 0}^{3} {\int }_{0}^{{T}_{i}} {g}_{jk} ( {x}_{s} , {x}_{r}^{i} , t ) {g}_{jl} ( {x}_{s} , {x}_{r}^{i} , t ) ⅆ t . \qquad [ 9 ]$$

The integration steps of [7] and [9] can be accelerated by using a time window t_min to t_max, where t_min is a time of arrival of a first energy from the source(fracture) as identified by an event detector and t_max is the maximum time for which the waveforms are matched, e.g., the time of arrival of the phase with maximum amplitude. This modification excludes the effect of reflections or tube waves in the recorded data.

When extracting the moment tensor M from three component recordings of the wavefield by solving the least squares inversion problem, the solution may not be stable as for example the matrix A may be rank deficient. To achieve a stable solution of this problem an algebraic regularization can be applied.

To regularize the problem only the largest eigenvalues are selected with a conditioning number below a predefined limit and a truncated decomposition of the singular values is performed. The matrix degree of singularity is measured by calculating the matrix conditioning number for each of the eigenvalues. The conditioning number is expressed by the ratio between of each eigenvalue and the largest eigenvalue. The threshold criterion consist in verify that the conditioning number do not exceeds the threshold value. Each conditioning number is compared to the threshold value. The number of the eigenvalues that satisfy the threshold criterion is equivalent to the rank of the matrix.

Once the number of eigenvalues k that provide linear independent solutions is determined, a truncated singular value decomposition is used to solve the inverse problem. The new inverse solution is calculated by the following expression:

$${\overline{M}}_{k} = {\sum }_{i = 1}^{k} \frac{{u}_{i}^{T} \cdot D}{{σ}_{i}} \cdot {v}_{i} \qquad [ 10 ]$$

Where M_bar is the stabilized moment tensor, D is the data vector, u and v are the eigenvectors and σᵢ are the eigenvalues obtained by the singular value decomposition. In the equation [10] only eigenvectors corresponding to the acceptable k eigenvalues are used to invert the matrix.

It is further feasible to associated with every recording device or trace a weighting function that indicates the quality of the receiver and/or recorded data. These weights could be introduced into the present equations [7] and [9].

The synthetic Green's function in equation [3] is then evaluated by computing three times N_r full waveform simulations (using a finite-differences). For each three-component receiver, three responses due to three orthogonal single force sources at the receiver positions are computed and derivatives of the velocity (or displacement) are stored at every possible source location, x_s. The synthetic seismograms are evaluated with a delta function as a source-time function. Using reciprocity, derivatives of Green's functions for every possible source location to every receiver position are evaluated. Equation [3] shows that six traces at every possible source location must be stored.

The above equation provides a complete set of steps to calculated the moment tensor M from three component recordings of the wavefield. The tensor itself is then decomposed to yield parameters characteristic of the fracture. Methods to decompose the moment tensor M have been developed for the purpose of analyzing earthquakes and are described for example by V. Vavrycuk in: Journal of Geophysical Research, Vol 106, No B8, Aug. 10, 2001, 16,339-16,355. The parameters obtained by such decomposition include the normal of the fracture n, the slip direction N, and products of the Lame coefficients with the slip u of the fracture, i.e., μu and λu respectively. Alternatively, the moment tensor can be inverted for a set of parameters including the orientation of the pressure P and tension T axes, parameter K=λ/μ and inclination α of the slip u from the fracture. These parameters provide information on the fracture orientation and slip direction which in turn can be used to control the hydraulic fracturing operation.

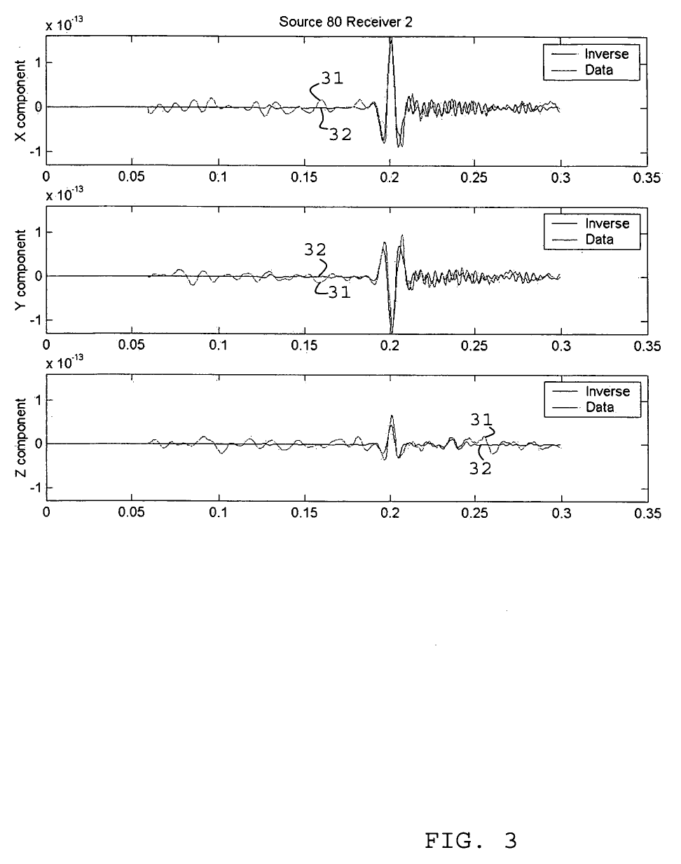

The accuracy of the inversion from recorded data d_j to the moment tensor M of the source can be further improved by bandlimiting the frequency of the data. While restricting data to a frequency range within the 0-100 Hz band yields satisfactory results, an improved accuracy is gained by limiting the data further to a frequency range within the 0-75 Hz and even a frequency range within the 0-50 Hz band. In FIG. 3 there is shown a plot of (synthetic) geophone velocity measurements 31 in x, y and z directions overlaid with the corresponding traces 32 re-calculated using the moment tensor derived by the method described above (with a known velocity model).

The above describes method and the variants thereof can be applied to the analysis of any other microseismic event.

1. A method of passively monitoring a subterranean location comprising the steps of obtaining multi-component signals of a microseismic event within the location; and performing a waveform inversion to determine parameters representing source characteristics of said microseismic event.

2. The method of claim 1 wherein the signal recordings are at least for the purpose of determining the source characteristics low-pass filtered or bandlimited to a frequency range within 0 to 100 Hz.

3. The method of claim 1 wherein the microseismic event is caused by a fracturing operation in a wellbore.

4. The method of claim 1 including the step of evaluating a Green's function to derive the source characteristics from the obtained signals.

5. The method of claim 1 wherein the obtained signals are processed to identify P-wave or S-wave events prior to the wavefield inversion.

6. The method of claim 1 wherein the parameters of the source characteristics are represented by a moment tensor and/or source location and/or origin time.

7. The method of claim 1 further comprising the step of using single value decomposition to stabilize the waveform inversion.

8. The method of claim 1 including the step of minimizing the difference between obtained signals and synthetic signals.

9. The method of claim 1 including the step of minimizing the difference between obtained signals and synthetic signals with the synthetic signals depending on the estimated source characteristics.

10. The method of claim 9 wherein the step of minimizing the difference between obtained signals and synthetic signals includes a search over source locations and origin times for an estimated source characteristics.

11. The method of claim 9 wherein the step of minimizing the difference between obtained signals and synthetic signals includes a grid search over source locations, origin times for an estimated source characteristics.

12. The method of claim 12 further comprising the steps of
estimating the initial origin time at possible source locations;
carrying out a search around the estimated origin time for each source location;
for said origin times finding the unique solution of a moment tensor of the source;
evaluating the least-square misfit between the recorded signals and synthetic signals derived by calculating the signals caused by a source of said moment tensor at the receiver locations; and
storing the best fitted solution for each source location.

13. The method of claim 1 wherein a source time function of the fracture is approximated by a delta function.
